(19) United States
(12) Patent Application Publication
(10) Pub. No.: US 2005/0100028 A1
(43) Pub. Date: May 12, 2005

(54) Medium hopping via a gateway

(75) Inventors: Robert C. Knauerhase, Portland, OR (US); Du V. Nguyen, Tigard, OR (US)

Correspondence Address: VENABLE, BAETJER, HOWARD AND CIVILETTI, LLP, P.O. BOX 34385, WASHINGTON, DC, 20043-9998, US

(73) Assignee: Intel Corporation, Santa Clara, CA (US)

(21) Appl. No.: 10/703,429

(22) Filed: Nov. 10, 2003

(51) Int. Cl. H04L 12/66

(52) U.S. Cl. 370/401; 370/331

(57) ABSTRACT

Providing an interface between a mobile device and a destination device may permit relatively seamless switching of connectivity between the mobile device and the destination device.

### BACKGROUND OF THE INVENTION

Mobile devices, such as mobile telephones, personal digital assistants (PDAs), and paging devices, have become ubiquitous in the world today. In our fast-paced society, we rely on such devices to give us greater flexibility in our daily lives, for business, family, and pleasure. With the proliferation of mobile network devices has come a proliferation of mobile networks.

With advances in network technologies come upgrades to networks. So, too, with different types of network communications (e.g., voice, facsimile, data), different types of network connections may exist within a particular network. Additionally, a particular mobile device may be capable of connecting to multiple networks and multiple different types of network connections within a single network. In traversing a network or networks, therefore, it is possible that a user will switch among various connections of various speeds and qualities of service and types.

Some wireless networks today permit switching between cells of the same network (e.g., from one cell to another), but the switching operation is not always transparent to the user application. It is also possible in many networks to have a multi-network mobile device (e.g., a multi-mode mobile telephone), but switching among networks is generally apparent to the end server. For example, the application and/or the server may need to address disruptions in service during switching operations. Furthermore, with, for example, IP networks, the server connection is generally re-established using a new network address, which may cause disruptions to be apparent.

Additionally, different connections within networks or in different networks may have different characteristics, for example, speed, latency, cost, or other factors or combinations of factors. As a result, not all connections may provide equivalent performance.

### BRIEF DESCRIPTION OF THE DRAWINGS

Preferred embodiments of the invention will now be described in connection with the associated drawings, in which:

FIG. 1 depicts a conceptual block diagram of a system implementing an embodiment of the invention;

FIG. 2 depicts a conceptual block diagram of an intermediate device according to an embodiment of the invention;

FIG. 3 depicts a flowchart of a method implementing an embodiment of the invention; and

FIG. 4 depicts a block diagram of a further embodiment of the invention.

### DETAILED DESCRIPTION OF PREFERRED EMBODIMENTS

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the term “coupled,” along with its derivatives, may be used. It should be understood that “coupled” may mean that two or more elements are in direct physical or electrical contact with each other or that the two or more elements are not in direct contact but still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

For the purposes of this disclosure, and in the appended claims, unless otherwise stated, a “connection” is not used to refer to a physical layer connection; rather, it refers to connection at least at the network layer (or higher) of the Open System Interconnect (OSI) protocol model. Examples of such connections include Internet Protocol (IP) sockets, logical connections, virtual connections, and other such types of higher-level connectivity.

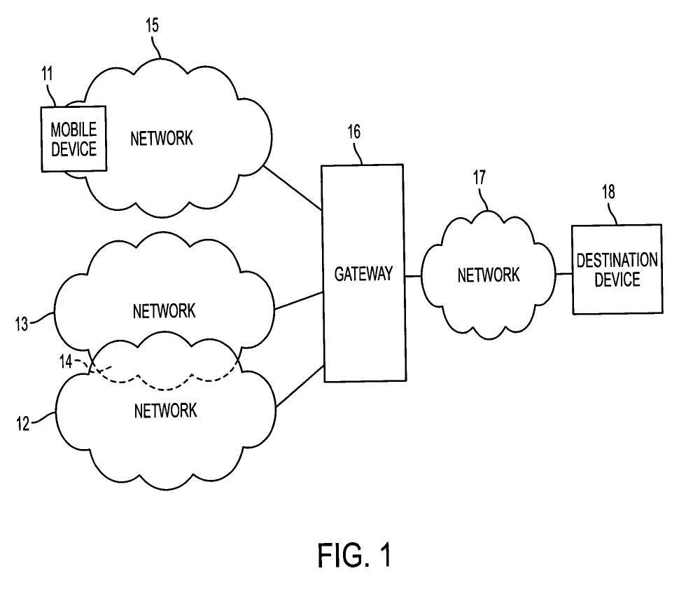

FIG. 1 depicts a system in which the present invention may be implemented. The mobile device 11 may run an application that requires communication with a destination device 18. The mobile device 11 may be capable of connecting to a number of networks 12, 13, 15. As shown, there may be regions in which the coverage areas of two or more networks overlap, e.g., the region denoted by reference numeral 14. Other networks, e.g., that denoted by reference numeral 15, may include multiple communication media. As mobile device 11 is moved from one location to another, the network or networks via which mobile device 11 will be capable of communicating may change. As a result, either of movement of mobile device 11 or variations or multiple media availability in a network serving mobile device 11 (i.e., mobile device 11 may actually be a stationary device, and the available medium or media may change; therefore, mobile device 11 is not to be understood as being limited to a device that may be easily moved or that actually does move), the actual routing of communications between the mobile device 11 and the destination device 18 may change.

In order to make the change in routing appear as seamless as possible, use may be made of an intermediate device or gateway 16. The gateway may be physically connected with each of networks 12, 13, and 15, as well as with network 17, via which it may establish and maintain a connection with destination device 18. Note that network 17 may be a “trivial” network, i.e., gateway 16 and destination device 18 may be directly physically connected. Once an application running on mobile device 11 causes a connection to be established with destination device 18 via gateway 16, the connection between gateway 16 and destination device 18 may be maintained, regardless of any switching of the connection between mobile device 11 and gateway 16.

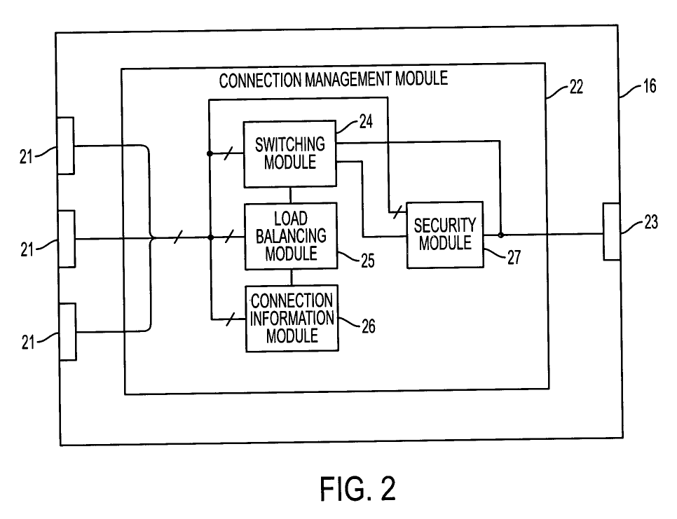

FIG. 2 shows a conceptual block diagram of how gateway 16 may be implemented. Gateway 16 may include physical connections 21 to the various networks via which the mobile device 11 may connect to the gateway 16. It may also include at least one physical connection 23 to a network (which, as discussed above, may be a trivial network) via which communication may be established with destination device 18. Physical connections 21, 23 may be coupled to a connection management module 22. Connection management module 22, which may be implemented in hardware, software, firmware, etc., or in combinations thereof, may play the role of establishing and managing connections between physical connections 21 and physical connection 23, as well as the connections established and maintained to the mobile device 11 and the destination device 18 via those physical connections 21, 23.

Connection management module 22, in turn, may comprise a number of components. First, connection management module 22 may include a switching module 24. Switching module 24 may perform the actual establishment of connections, possibly in concert with other components of connection management module 22.

Next, connection management module 22 may include a security module 27, which may be coupled to physical connections 21, 23 and to switching module 24. Security module 27 may deal with authentication and privacy aspects of the connections. Such functions may include, but are not limited to, encryption/decryption, login procedures, and the like.

For example, in implementing a login procedure, the switching module 24 may first establish a provisional connection with mobile device 11 via a physical connection 21. The security module 27 may then exchange information with a mobile device 11 via a physical connection 21 and determine if the mobile device 11 is permitted access. If permitted access, security module 27 may indicate this to the switching module 24, thus providing permission to establish a connection (or equivalently, to let the provisional connection remain). Note that the procedures implemented by security module 27 are not, however, limited to such login procedures and may include other login procedures or security-related functions.

The connection management module 22 may further include a connection information module 26. Connection information module 26 may provide performance-related information (and possibly other information) to a mobile device 11 via a physical connection 21. For example, when a mobile device 11 establishes a connection to gateway 16, it might be located in a particular network 12, 13, or 15 (see FIG. 1). The mobile device 11 may then move, e.g., to a region (e.g., that denoted by reference numeral 14) in which a connection to the gateway 16 may be established via more than one network (and/or medium, e.g., in the case of network 15). The mobile device 11 may then seek to establish a second connection via a new network. The connection information module 26 may provide information related to communication performance via the new network and/or comparative communication performance of the previous and new networks. Such information may include, but is not limited to, for example, speed, latency, cost, or other quality-of-service-related quantities, or functions of one or more of these. The information may be provided in response to a query received from mobile device 11. This information may then be used by mobile device 11 to decide via which network to remain connected to gateway 16.

The connection management module 22 may further include a load balancing module 25. Load balancing module 25 may be coupled to the physical connections 21 and/or to switching module 24 to monitor the communication traffic on each of the physical connections (i.e., on each of the networks 12, 13, 15). This information may then be furnished to the connection information module 26 and, in turn, sent to the mobile device 11, to aid the mobile device 11 in determining by which network to connect.

Load balancing module 25 may further include or interact with other modules performing other network management functions, as desired, including, for example, adaptive costing based on relative loading of a network (e.g., as the load on a particular network increases, the cost of obtaining a connection via that network may be adaptively increased in order to control further loading of that network).

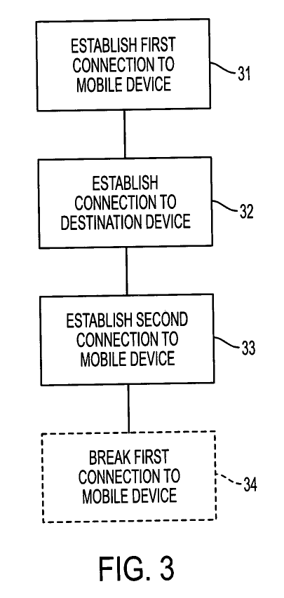

Operation of the gateway 16 will now be described in connection with the flowchart of FIG. 3, which illustrates the process that may occur when a mobile device 11 switches networks and/or media within a network. First, in Block 31, gateway 16, upon receiving appropriate signals from an application running on a mobile device 11 via a network 12, 13, or 15, may establish a first connection to mobile device 11 via, for example, network 12. This process may involve authentication and/or other security procedures, which may be carried out by security module 27.

In conjunction with the connection to mobile device 11 in Block 31, gateway 16 may further establish a connection to a desired destination device 18 in Block 32. The destination device 18 may be determined by the application running on mobile device 11.

Upon moving or otherwise determining that it is within the coverage area of another network or communications medium, mobile device 11 may seek to establish a second connection. Again, after any security procedures, the gateway 16 may establish such a connection (Block 33), if possible. While establishing the second connection, the connection between gateway 16 and destination device 18 may be maintained without interruption. In particular, the connection between gateway 16 and destination device 18 may be maintained at least for the duration of the application being run on the mobile device 11.

Upon establishment of the second connection, the mobile device 11 may then opt to drop one of the connections. This may be based on the fact that the mobile device 11 has been relocated, or it may be based on some other criterion or criteria (e.g., cost, speed, etc.), information about which may have been provided by the gateway (e.g., by the connection information module 26). After appropriate signals have been exchanged, the gateway 16 may then drop one of the connections to mobile device 11, leaving a single connection (Block 34).

Note that, in some circumstances, it may be desirable for a mobile device to maintain multiple connections simultaneously. As a result, Block 34 may be an optional procedure, which may be demanded by the particular mobile device 11, except where the mobile device moves out of the range of a particular network. In this latter case, Block 34 may be made mandatory for the connection via that network, in order to free connections for other mobile devices.

As discussed above, connections may be of many types, and the connection between the mobile device 11 and the gateway 16 need not be the same type of connection as that between the gateway 16 and the destination device 18. Such connections may include, for example, IP sockets, Signaling System 7 (SS7) connections, or other types of connections.

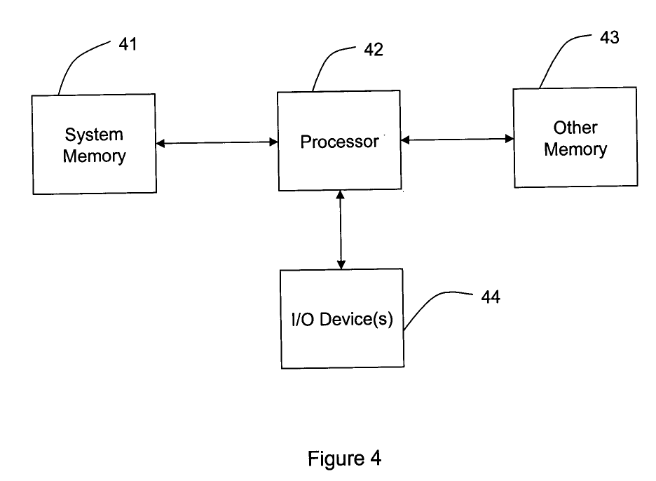

Some embodiments of the invention, as discussed above, may be embodied in the form of software instructions on a machine-readable medium. Such an embodiment is illustrated in FIG. 4. The computer system of FIG. 4 may include at least one processor 42, with associated system memory 41, which may store, for example, operating system software and the like. The system may further include additional memory 43, which may, for example, include software instructions to perform various applications. The system may also include one or more input/output (I/O) devices 44, for example (but not limited to), keyboard, mouse, trackball, printer, display, network connection, etc. The present invention may be embodied as software instructions that may be stored in system memory 41 or in additional memory 43. Such software instructions may also be stored in removable or remote media (for example, but not limited to, compact disks, floppy disks, etc.), which may be read through an I/O device 43 (for example, but not limited to, a floppy disk drive). Furthermore, the software instructions may also be transmitted to the computer system via an I/O device 43, for example, a network connection; in such a case, a signal containing the software instructions may be considered to be a machine-readable medium.

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. A method, comprising:
maintaining a connection between an intermediate device and a destination device for at least the duration of an application being run on a mobile device and communicating with the destination device;
detecting a connection between the intermediate device and the mobile device via a second connection providing connectivity to the mobile device, while maintaining a connection between the intermediate device and the mobile device via a first connection providing connectivity to the mobile device;
switching the connection between the intermediate device and the mobile device from the first connection to the second connection.

2. The method according to claim 1, wherein said detecting a connection via a second connection comprises:
receiving a message from the mobile device via at least one of the first connection and the second connection, said message informing the intermediate device of the existence of the second connection.

3. The method according to claim 1, further comprising:
establishing a connection between the intermediate device and the destination device in response to a connection to the intermediate device from an application running on the mobile device.

4. The method according to claim 1, wherein said switching the connection comprises:
providing the mobile device with performance information about at least the second connection.

5. The method according to claim 4, wherein said performance information includes at least one of speed, latency, cost, and quality of service.

6. The method according to claim 4, wherein said providing the mobile device with performance information comprises:
receiving a query from the mobile device, requesting performance information about at least the second connection.

7. The method according to claim 4, wherein said switching the connection further comprises:
switching the connection in response to a signal received from the mobile device, indicating that the connection should be switched.

8. The method according to claim 1, wherein said switching the connection comprises:
receiving a signal from the mobile device indicating that the connection should be switched.

9. The method according to claim 1, wherein said switching the connection comprises:
maintaining the first connection while communication takes place via the second connection.

10. The method according to claim 1, wherein said switching the connection comprises:
dropping the first connection after switching to the second connection.

11. A machine-readable medium that provides instructions, which when executed by a computing platform, cause said computing platform to perform operations comprising a method of:
maintaining a connection between an intermediate device and a destination device for at least the duration of an application being run on a mobile device and communicating with the destination device;
detecting a connection between the intermediate device and the mobile device via a second connection providing connectivity to the mobile device, while maintaining a connection between the intermediate device and the mobile device via a first connection providing connectivity to the mobile device;
switching the connection between the intermediate device and the mobile device from the first connection to the second connection.

12. The machine-readable medium according to claim 11, wherein said detecting a connection via a second connection comprises:
receiving a message from the mobile device via at least one of the first connection and the second connection, said message informing the intermediate device of the existence of the second connection.

13. The machine-readable medium according to claim 11, providing further instructions, which when executed by a computing platform, cause the computing platform to perform a further operation of:
establishing a connection between the intermediate device and the destination device in response to a connection to the intermediate device from an application running on the mobile device.

14. The machine-readable medium according to claim 11, wherein said switching the connection comprises:
providing the mobile device with performance information about at least the second connection.

15. The machine-readable medium according to claim 14, wherein said performance information includes at least one of speed, latency, cost, and quality of service.

16. The machine-readable medium according to claim 14, wherein said providing the mobile device with performance information comprises:
receiving a query from the mobile device, requesting performance information about at least the second connection.

17. The machine-readable medium according to claim 14, wherein said switching the connection further comprises:
switching the connection in response to a signal received from the mobile device, indicating that the connection should be switched.

18. The machine-readable medium according to claim 11, wherein said switching the connection comprises:
receiving a signal from the mobile device indicating that the connection should be switched.

19. The machine-readable medium according to claim 11, wherein switching the connection comprises:
maintaining the first connection while communication takes place via the second connection.

20. The machine-readable medium according to claim 11, wherein switching the connection comprises:
dropping the first connection after switching to the second connection.

21. An apparatus, comprising:
physical connections adapted to connect to at least two communication media via which a connection may be established with a mobile device;
at least one physical connection adapted to connect to at least one communication medium via which a connection may be established with a destination device; and
a connection management module, coupled to said physical connections adapted to connect to at least two communication media and to said at least one physical connection adapted to connect to at least one communication medium, the connection management module being adapted to manage connections over the physical connections, wherein the connection management module is adapted to switch connections to the mobile device without interrupting a connection to the destination device.

22. The apparatus according to claim 21, wherein the connection management module comprises:
a connection information module adapted to send information about one or more connections to the mobile device.

23. The apparatus according to claim 22, wherein the connection management module further comprises:
a load balancing module adapted to monitor the communication media via which a connection may be established with the mobile device and to provide information, based on monitoring the communication media, to the connection information module.

24. The apparatus according to claim 21, wherein the connection management module comprises:
a connection switching module adapted to switch connections from one of the communication media via which a connection may be established with the mobile device to another one of the communication media via which a connection may be established with the mobile device, said switching in response to a signal from the mobile device.

25. The apparatus according to claim 21, wherein the connection management module comprises:
a security module adapted to communicate security information between the mobile device and the intermediate device.

26. A system, comprising:
an intermediate device adapted to support and maintain connectivity between a mobile device, through at least one first communication medium, and a destination device, through a second communication medium;
wherein the intermediate device is adapted to maintain connectivity between the intermediate device and the destination device via the second communication medium for at least the duration of an application running on the mobile device while switching connectivity between the intermediate device and the mobile device among first communication media.

27. The system according to claim 26, wherein the intermediate device comprises a connection management module.

28. The system according to claim 27, wherein the connection management module includes one or more of the following modules: a switching module, a security module, a connection information module, and a load balancing module.
